(19) United States
(12) Patent Application Publication
(10) Pub. No.: US 2024/0152164 A1
(43) Pub. Date: May 9, 2024

(54) Nanometer Manufactured Artificial Intelligence Flow Control Liquid-to-gas Conversion Method

(71) Applicants: Charles H Ng, Palo Alto, CA (US); HokChung Ng, Toronto (CA)

(72) Inventors: Charles H Ng, Palo Alto, CA (US); HokChung Ng, Toronto (CA)

(21) Appl. No.: 18/221,224

(22) Filed: Jul. 12, 2023

Related U.S. Application Data
(60) Provisional application No. 63/424,118, filed on Nov. 9, 2022.

(51) Int. Cl. G05D 7/06

(52) U.S. Cl. CPC G05D 7/0694

(57) ABSTRACT

Electron exchangers are placed in the conversion cell and divide it into cathode gas chamber, liquid conversion solution chamber together with a liquid flow controller, and anode gas chamber. Voltage is applied to the electron exchangers to convert the liquid conversion solution to gases, and gases are released directly to the gas chambers. There are many puncture channels on the surfaces of the liquid flow controller, and they are designed by critical surface calculations. The puncture channels have special designed patterns and are manufactured with a precision technology. A microprocessor connected to the cloud is responsible for artificial intelligence calculations, and it controls liquid and gas flow valves in the conversion cell. In producing the same amount of final gases, our method is energy efficient.

### CROSS-REFERENCE TO RELATED APPLICATIONS

This application claims the benefit of Provisional Patent Application Ser. 63/424,118 filed Nov. 9, 2022 by the present inventors, which is incorporated by reference in its entirety.

### TECHNICAL FIELD

The present invention relates to liquid to gas conversion method with an electrical voltage, specifically to such a method which is energy efficient.

### BACKGROUND ART

It is known in the prior art that liquid-to-gas conversion is commonly achieved by the application of a voltage to a liquid conversion solution through two pieces of conductive materials to produce final gases. With two pieces of conductive materials immersed in the liquid conversion solution, as anode and cathode, the conductive materials are under direct contact with the liquid conversion solution. Electrons are exchanged between these conductive materials and the liquid conversion solution, and final gases are released as bubbles from the immersed conductive materials. The gases float upward from the liquid conversion solution to the gas chambers above. This prior process is generally not energy efficient.

### SUMMARY

Our method provides an energy efficient liquid-to-gas conversion using nanometer-manufactured artificial intelligence flow control conversion cell.

### DRAWINGS—FIGURES

FIG. 1: Liquid flow controller built by stacking multiple flow control single sheets to control the flow of liquid conversion solution

FIG. 2: Liquid-to-gas conversion cell with electron exchangers and liquid flow controller

FIG. 3: Stacking of conversion cells horizontally and vertically

FIG. 4: Y, X, and star patterns for puncture channels

### DRAWINGS—REFERENCE NUMERALS

100: Liquid flow controller
110: How control single sheets
210: Cathode gas chamber
220: Anode gas chamber
230: Liquid conversion solution chamber with the liquid flow controller
240: Cathode electron exchanger
250: Anode electron exchanger
260: Liquid reservoir
270: Liquid conversion solution
280: Liquid flow valve
290: Liquid content sensor
300: Hygrometer (HGO)
310: Microprocessor (MCU)
410: Liquid-to-gas conversion cell

### DESCRIPTION

Our method discloses a nanometer manufactured artificial intelligence flow control liquid-to-gas conversion method.

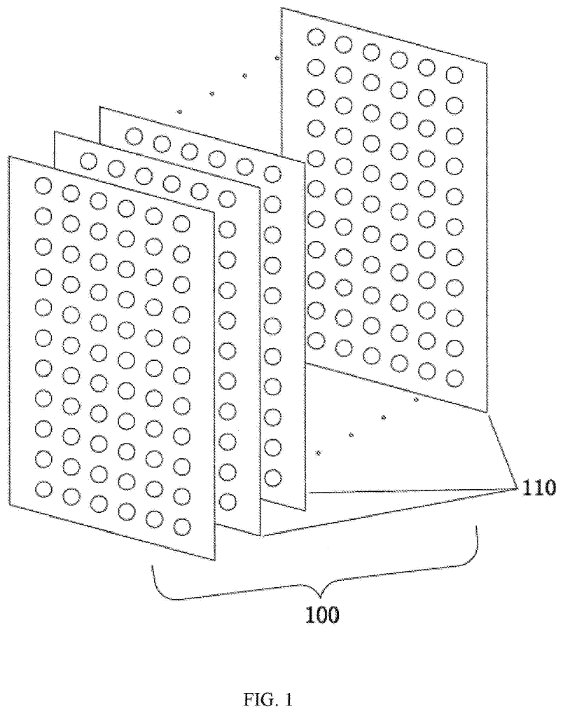

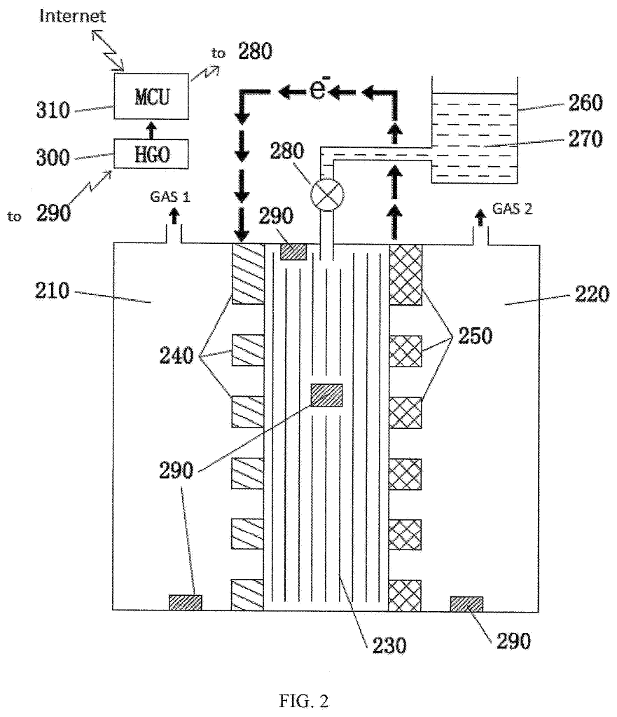

The anode electron exchanger 250 and the cathode electron exchanger 240 in the liquid-to-gas conversion cell are placed in the conversion cell (FIG. 2), and the conversion cell is divided, from one side to the other side, into the cathode gas chamber 210, the cathode electron exchanger, the liquid conversion solution chamber filled with the liquid flow controller 230, the anode electron exchanger, and the anode gas chamber 220 (FIG. 1). The liquid flow controller 100 is composed of multiple nonconductive flow control single sheets 110 stacked together

The nonconductive sides of the electron exchangers facing the liquid conversion solution chamber are in direct contact with the liquid flow controller. The other sides of the electron exchangers facing the gas chambers are conductive. The surfaces of the electron exchangers are covered with multiple puncture channels.

Liquid conversion solution 270 is fed into the liquid flow controller inside the liquid conversion solution chamber from the liquid reservoir 260, and voltage is applied to the anode electron exchanger and the cathode electron exchanger. Liquid conversion solution passes through the puncture channels of the electron exchangers from the liquid flow controller to the conductive sides of the electron exchangers. Electrons are exchanged on the conductive sides of electron exchangers facing the gas chambers, and the liquid conversion solution is converted into final gases, releasing separately into the cathode gas chamber and the anode gas chamber.

A liquid flow valve 280 is placed at liquid inlet of the liquid flow controller to control the flow of liquid conversion solution from the liquid reservoir to the liquid flow controller. Solvent is added to the liquid conversion solution to ionize the molecules of the liquid conversion solution. The working temperature of the conversion cell is adjusted to approximately close to normal room temperature, and the operating pressure inside the different chambers of the conversion cell is adjusted to approximately close to normal sea level atmospheric pressure. Gas flow valves are placed at the gas outlets of cathode and anode gas chambers. By using artificial intelligence calculations, a microprocessor controls the liquid flow valve and the gas flow valves to adjust the working temperature, liquid pressure, and gas pressure in different chambers of the conversion cell to improve the gas production level and the energy efficiency of the conversion cell.

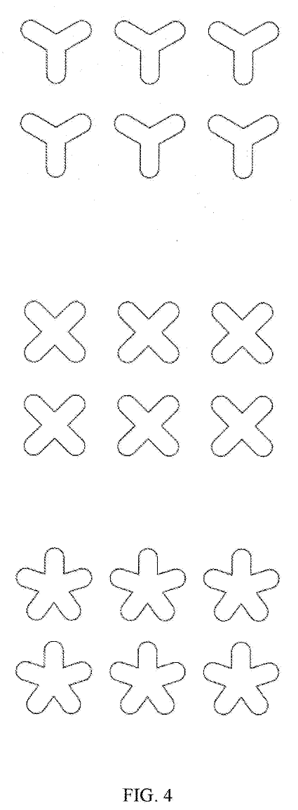

Multiple nonconductive flow control single sheets are stacked together to form the liquid flow controller, and the number of flow control single sheets ranges from 2 to 10,000 sheets or more. There are multiple puncture channels on the surface of the flow control single sheet. The sizes of the puncture channels are designed by critical surface calculations. Also, the puncture channels of the electron exchangers are designed and manufactured in a similar way as the puncture channels of the flow control single sheets. The puncture channels control the rate and amount of the liquid conversion solution in passing through the flow control single sheets. The puncture channels have special designed Y-shaped, X-shaped, and star-shaped patterns (FIG. 4). The patterns enhance the ability of liquid conversion solution to adhere to the surfaces of the flow control single sheets;

When the flow control single sheets are stacked together, the puncture channels from adjacent flow control single sheets are kept out of alignment with each other. In other words, the puncture channels from adjacent flow control single sheets are located at different positions from each other, and they are separated to form a pattern of interlocking puncture channels. These interlocking puncture channels enhance the ability of liquid conversion solution to adhere to the surfaces of the flow control single sheets.

The flow control single sheets are manufactured by a precision technology selected from a list of options comprising: chemical etching, plasma etching, laser drilling or electroforming. The first option of chemical etching process is applied to a piece of conductive material to etch away specific points of the material to form the puncture channels. As the second option, it is also possible to apply plasma etch on a nonconductive polymer material to etch away specific spots of the nonconductive polymer material to form the puncture channels. The third option is laser drilling, in which a piece of conductive or nonconductive material that meets the requirements is repeatedly applied with pulsing focused laser energy to cut through the material to form the puncture channels. A fourth option is electroforming, where nanometer scale or micrometer scale metal devices are fabricated by electrodepositing on a pattern called a mandrel. The desired conductive material is electrodeposited on the mandrel to form the flow control single sheet and the puncture channels. If the making of the flow control single sheet starts from a conductive material, after the puncture channels are made by one of the above processes, the surface of the conductive material is coated with a nonconductive polymer material to make the flow control single sheet nonconductive on one side.

The design of the liquid flow controller, the flow control single sheet, and the puncture channels is the key to control the liquid conversion solution to adhere to the flow control single sheets, and to make the liquid conversion solution form thin films on the flow control single sheets. The thickness of the flow control single sheets, the spacing between adjacent flow control single sheets, the size of the puncture channels, and the distance separating the puncture channels should not be too large or too small, in the range of nanometers to micrometers, and should be calculated by the following method.

The liquid conversion solution stays on the critical surface of the flow control single sheet as droplets. It will diffuse until a partial wetting equilibrium contact radius is reached. For a simple estimation calculations, the droplet radius r can be expressed as:

$$r = \sqrt{\frac{V}{π h}} , where h = \sqrt{\frac{2 σ ( 1 - cos θ )}{ρ g}}$$

σ is the surface tension
g is the gravitational acceleration constant
θ is the contact angle between the liquid and the surface
h is the height of the droplet
V is the time function of the volume of the droplet

Using a more detailed model and calculations, the change in droplet radius over time r(t) can be expressed as:

$$r ( t ) = {{r}_{e} [ 1 - exp ( - ( \frac{2 {γ}_{LG}}{{r}_{e}^{12}} + \frac{ρ g}{9 {r}_{e}^{10}} ) \frac{24 λ {V}^{4} ( t + {t}_{0} )}{{π}^{2} η} ) ]}^{\frac{1}{6}}$$

It is also possible to assume perfect spreading of the liquid conversion molecules and radius over time r(t) can be expressed as:

$$r ( t ) = {[ {( {γ}_{LG} \frac{96 λ {V}^{4}}{{π}^{2} η} ( t + {t}_{0} ) )}^{\frac{1}{2}} + {( \frac{λ ( t + {t}_{0} )}{η} )}^{\frac{2}{3}} \frac{24 ρ {gV}^{\frac{3}{8}}}{7 \cdot {96}^{\frac{1}{3}} {π}^{\frac{4}{3}} {γ}_{LG}^{\frac{1}{3}}} ]}^{\frac{1}{6}}$$

γLG is the surface tension of the liquid
V is the droplet volume
η is the viscosity of the liquid
ρ is the density of the liquid
g is the gravitational acceleration constant
λ is the shape factor, 37.1 m-1
t0 is the experimental delay time
re is the radius of the droplet at equilibrium

Assuming the delay time is approximately 0.1 to 2 seconds to calculate the droplet radius, the spacing between adjacent puncture channels of flow control single sheets should be set as approximately 100% to 200% of the droplet radius over time r(t).

The radii of the puncture channels of flow control single sheets should be set approximately no larger than the radius over time r(t). In common liquid conversion solution materials, the diameters of the puncture channels can be approximately 100 nanometers to 100 micrometers. The spacing and the radii of the puncture channels can be adjusted based on the operating temperature, liquid pressure, gas pressure, and the desired gas production level.

On the same flow control single sheet, the size and the spacing of the puncture channels can be smaller or larger depending on their distances away from the source of the liquid conversion solution flowing into the flow control single sheet.

The thickness of the flow control single sheet and the distance between adjacent flow control single sheets can be calculated in the following:

The height h of a liquid column is given as

$$h = \frac{2 γcosθ}{ρ gr}$$

γ is the liquid-air surface tension coefficient (force/unit length),
Θ is the contact angle,
ρ is the density of liquid,
g is the gravitational acceleration constant, and
r is the radius over time r(t).

The thickness of the puncture channels of the flow control single sheet should be as approximately no thicker than h. The thickness of the sheet is approximately 100 nanometers to 100 microns in common liquid conversion solution materials.

The liquid flow controller is formed by stacking multiple flow control single sheets, and the spacing between adjacent flow control single sheets should not be greater than approximately 50% to 100% of h. In common liquid conversion solution materials, the spacing between adjacent flow control single sheets is approximately between 50 nanometers and 100 microns. The thickness and the spacing of the flow control single sheet can be adjusted according to the operating temperature, liquid pressure, gas pressure, and the desired gas production level.

The conversion cell is equipped with an intelligent microprocessor (MCU) 310 responsible for the artificial intelligence machine learning calculations. The liquid flow valve is placed at liquid inlet of the liquid flow controller. The microprocessor controls the liquid flow valve and decides whether to open or close the valve, increase or slow the flow of the liquid conversion solution from the liquid reservoir to the liquid flow controller.

The microprocessor is connected to the hygrometer 300 with four liquid content sensors 290 inside the conversion cell, and more liquid content sensors can be placed at selected locations of the conversion cell. Each sensor has a pair of resistance probes to sense the liquid content of the liquid conversion solution at different locations in the conversion cell. The probes are made of anti-corrosion and anti-oxidation conductive materials, or they can be coated with highly conductive anti-corrosion and anti-oxidation materials to prevent the probe from oxidation over time.

The first liquid content sensor is placed at the liquid inlet side of the liquid flow controller, and the second liquid content sensor is placed near the middle area of the liquid flow controller in order to detect the liquid content of the liquid conversion solution in these locations. If the microprocessor senses the lack of liquid conversion solution at these sensor locations, the microprocessor opens the liquid flow valve to let more liquid conversion solution flow from the liquid reservoir to the liquid flow controller. When the microprocessor senses enough liquid conversion solution at these sensor locations, the microprocessor closes the liquid flow valve and slow the flow of liquid conversion solution from the liquid reservoir.

The third and fourth liquid content sensors are placed at the bottom of the cathode gas chamber, and the bottom of the anode gas chamber. If the microprocessor senses certain amount of liquid conversion solution at these locations because there is too much liquid conversion solution entering the liquid flow controller, and the electron exchanger cannot keep up with the liquid-to-gas conversion. The microprocessor turns off the liquid flow valve to slow the liquid conversion solution flow to the liquid flow controller, and let the electron exchanger catch up with the liquid-to-gas conversion.

The microprocessor is connected to and exchange data with temperature sensors, liquid pressure sensors, and gas pressure sensors placed inside the anode gas chamber, cathode gas chambers, liquid conversion solution chamber, or next to these chambers of the conversion cell. The microprocessor is connected to two gas flow sensors placed at the gas outlets of the cathode and the anode gas chambers. The microprocessor adjusts the liquid flow valve and the gas flow valves, affecting the working temperature, liquid pressure, and the gas pressure inside or next to the various chambers of the conversion cell, and affecting the gas output level at the gas outlets of the gas chambers. The microprocessor's control action improves the gas production level and the energy efficiency of the conversion cell.

The microprocessor transmits the data to the cloud computing engine through the Internet to perform the artificial intelligence calculations and store the data in the cloud storage. Due to security concerns, these data can also be transmitted to the local computing engine through wired or wireless network, and the artificial intelligence calculations can be completed in the local microprocessor and local computing engine.

The combined use of microprocessor, local computing engine, and cloud computing engine calculates the control instructions from the analysis results, and transmits the control instructions to control the liquid flow valve, gas flow valves, and the sensors. At the same time, human operators can read the data and the artificial intelligence calculations results through wired or wireless networks from mobile phones and computer devices.

Machine learning is specifically a predictive modeling technique, and the main objective is to minimize the error of the model, and to make the most accurate prediction possible. Machine learning algorithms are described as learning target predictive function that can be used to predict output data based on future input data. Through the training of a large amount of previous data, the machine learning model continues to learn and improve its accuracy in predicting the output data from future new input data.

Machine learning algorithm is described as learning an objective prediction function (F) that best maps an input variable (X) to an output variable (Y), in other words, predicts an output (Y) based on an input (X).

Y=F(X)

Regression analysis is used for the artificial intelligence machine learning calculations and it can use a combination of 1) single variable regression, 2) multi variable regression, 3) linear regression, and 4) nonlinear regression.

For illustration, an example will be shown using a multi variable linear regression function with predictive function F(X) for the machine learning calculations, and the same principle can be applied to use different combinations of single variable regression, multiple variable regression, linear regression and nonlinear regression for the machine learning calculations.

When building and training the model, the regression function F(X) is described as follows:

Y=F(X)

Y=C+M1×X1+M2×X2+M3×X3+ . . . +Mn×Xn

Let
Multi variable linear regression prediction function F(X)
Commonly accepted decision parameter=Y
Sensor 1 data=X1
Sensor 2 data=X2
Sensor N data or required gases output level=Xn
Sensors 1 . . . N can be the liquid content sensors, temperature sensors, liquid pressure sensors, gas pressure sensors, and gas flow sensors. In processing working temperature and working pressure, if the temperature and pressure are within an accepted range, then Xn is set to 1, otherwise it is set to 0.

Based on the value of decision parameter Y, control commands are sent to control the liquid flow valve and gas flow valves. The result is this machine learning model controls the flow of the liquid conversion solution from the liquid reservoir to the liquid flow controller. Decision parameter Y is also used in a similar way to control gas flow valves to control gas out flow from the outlets of the gas chambers.

When training a machine learning model, more and more sensor data and the “commonly accepted decision parameters” are collected and fed into the model. The prediction function F is calculated and will become more and more accurate. The coefficients C, M1, M2, . . . Mn will become more and more accurate. When the model is fully trained with enough training data, the model can be used (using function F, coefficient C, M1, M2, . . . Mn) with new sensor data to predict future decision parameters.

This method of liquid-to-gas conversion utilizes artificial intelligence machine learning to control the liquid conversion solution flow. At the side of the electron exchangers facing the gas chambers, the liquid conversion solution is converted into final gases and directly released into the gas chambers. The power consumed by the conversion cell will be optimized.

This liquid-to-gas conversion method can be used to convert different kinds of liquid conversion solution into different kinds of gases, and this conversion method can also be used to convert liquid water to hydrogen and oxygen gases.

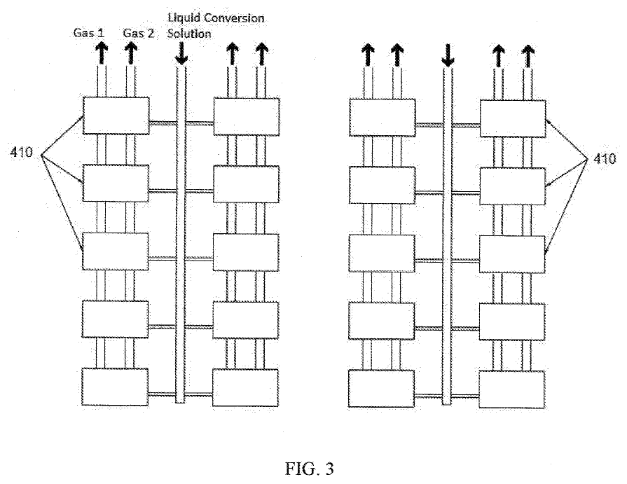

Multiple conversion cells 410 can be stacked vertically and horizontally (FIG. 3), and more conversion cells can be placed in the same physical space to achieve higher gas production level. Common components can be shared by multiple conversion cells.

### Operation:

In the following example, we describe our method using water as liquid conversion solution to generate hydrogen and oxygen gases, but the principle of our method can be generalized to apply to other types of liquid conversion solutions to generate other types of gases. The following described embodiment is only one of the, but not all, embodiments of our presented method. Based on the embodiments of our presented method, all other embodiments obtained by those of ordinary skill in the art without creative efforts shall fall within the protection scope of our presented method.

The anode electron exchanger and cathode electron exchanger are placed in the liquid-to-gas conversion cell, and the conversion cell is separated into the cathode gas chamber, the liquid conversion solution chamber filled with the liquid flow controller, and the anode gas chamber.

The surface of the electron exchanger is covered with puncture channels. The nonconductive side of the electron exchanger faces the liquid conversion solution chamber and it is in direct contact with the liquid flow controller. The other conductive side of the electron exchanger faces the gas chamber. The liquid flow controller is formed by stacking together multiple nonconductive flow control single sheets. The surface of the flow control single sheets is covered with multiple puncture channels.

Water is used as the liquid conversion solution and is stored in the liquid reservoir. Water is fed via the liquid flow valve into the liquid flow controller inside the liquid conversion solution chamber. Potassium hydroxide is added to the water to ionize the liquid water molecules. By applying a voltage to the cathode and anode electron exchange, electrons are exchanged on the side of electron exchangers facing the gas chambers, and water is converted into hydrogen and oxygen gases releasing into the cathode gas chamber and the anode gas chamber.

The water in the liquid flow controller is in contact with the anode electron exchanger and the cathode electron exchanger. Water molecules pass through the puncture channels of the cathode electron exchanger, and reach the conductive side of the cathode electron exchanger facing the cathode gas chamber. At this side, electrons from the cathode electron exchanger are released into the water to reduce the water to hydrogen and hydroxide root ion, and hydrogen gas is released into the cathode gas chamber. The hydroxide ions from the cathode electron exchanger flow through the liquid flow controller, pass through the puncture channels of the anode electron exchanger, and reach the conductive side of the anode electron exchanger facing the anode gas chamber. At this side, the hydroxide ions are converted into water, oxygen and electrons. The electrons are collected by the anode electron exchanger, and the oxygen gas is released to the anode gas chamber.

The result is hydrogen and oxygen gases are collected separately from the two gas chambers. As more gas is produced, the water content in the liquid flow controller goes down, and the microprocessor senses the low water content. After executing artificial intelligence calculations, the microprocessor opens the liquid flow valve, allowing more water from the liquid reservoir to flow to the liquid flow controller. The result of our conversion method provides an energy efficient liquid-to-gas conversion method to generate hydrogen and oxygen gases from liquid water.

### Conclusion, Ramifications, and Scope:

While the above description contains much specificity, these should not be construed as limitations on the scope of the invention, but rather as an exemplification of one preferred embodiment thereof. Many other variations are possible.

For example, we describe our method using an example of water as liquid conversion solution to generate hydrogen and oxygen gases, but the principle of our method can be generalized to apply to other types of liquid conversion solutions to generate other types of gases.

For example, we describe our method in manufacturing the puncture channels using precision technologies, comprising: chemical etching, plasma etching, laser drilling or electroforming. The puncture channels can possibly be manufactured by other kinds of technologies that are not listed in our described list of technologies, but the principle of our method can be generalized to apply to manufacturing the puncture channels with technologies that are able to create similar small openings.

For example, we describe our machine learning regression method by using a multi variable linear regression method as an illustration, but the principle of our regression method can be generalized to applying a combination of 1) single variable regression, 2) multi variable regression, 3) linear regression, and 4) nonlinear regression.

The described embodiment in the above description is only one of the, but not all, embodiments of our presented method. Based on the embodiments of our presented method, all other embodiments obtained by those of ordinary skill in the art without creative efforts shall fall within the protection scope of our presented method.

The scope of the invention should be determined not by the embodiments illustrated, but by the appended claims and their legal equivalents.

I claim:

1) A method for nanometer manufactured artificial intelligence flow control conversion of liquid to gas, comprising:
placing a liquid flow controller in a liquid conversion solution chamber inside a conversion cell;
feeding liquid conversion solution to said liquid flow controller in said liquid conversion solution chamber inside said conversion cell;
placing electron exchangers, built with one or more puncture channels, in said conversion cell, comprising: cathode electron exchanger, and anode electron exchanger;
setting gas chambers in said conversion cell, comprising: cathode gas chamber, and anode gas chamber;
placing said electron exchangers in between said liquid conversion solution chamber and said gas chambers inside said conversion cell;
enabling said liquid conversion solution passing from said liquid flow controller through one or more said puncture channels of said electron exchangers;
applying a voltage to said anode electron exchanger and said cathode electron exchanger; and
converting said liquid conversion solution into gases releasing to said gas chambers in said conversion cell.

2) The method of claim 1 wherein said placing said electron exchangers further comprises:
using said electron exchangers with one conductive side and one nonconductive side in said conversion cell;
placing said nonconductive sides of said electron exchangers facing said liquid flow controller in said liquid conversion solution chamber and in contact with said liquid conversion solution in said liquid flow controller;
placing said conductive side of said cathode electron exchanger facing said cathode gas chamber; and
placing said conductive side of said anode electron exchanger facing said anode gas chamber.

3) The method of claim 1 wherein said placing said liquid flow controller in said liquid conversion solution chamber, further comprises:
building said liquid flow controller by actions selected from any combination of one or more options, comprising:
building nonconductive flow control single sheets with one or more said puncture channels following design parameters;
stacking two or more said flow control single sheets together to build said liquid flow controller following design parameters;
enabling said liquid conversion solution passing through one or more said puncture channels of said flow control single sheets of said liquid flow controller; and
enabling said flow control single sheets with one or more said puncture channels to control rate and amount of said liquid conversion solution in passing through said flow control single sheets.

4) The method of claim 3 wherein said stacking two or more said flow control single sheets together to build said liquid flow controller, further comprises:
setting one or more said puncture channels from adjacent said flow control single sheets to be out of alignment with each other, forming a pattern of interlocking said puncture channels in between adjacent said flow control single sheets.

5) The method of claim 3 wherein said building nonconductive said flow control single sheets with one or more said puncture channels following design parameters, further comprises with actions selected from any combination of one or more options, comprising:
modeling said liquid conversion solution adhering on surfaces of said flow control single sheets as droplets and diffusing until a partial wetting equilibrium contact radius is reached;
expressing said droplets with radius r as:
$$r = \sqrt{\frac{V}{π h}} , where h = \sqrt{\frac{2 σ ( 1 - cos θ )}{ρ g}} ,$$
σ is the surface tension
g is the gravitational acceleration constant
θ is the contact angle between the liquid and the surface
h is the height of the droplet
V is the time function of the volume of the droplet
expressing said droplet with said radius over time r(t) as:
$$r ( t ) = {{r}_{e} [ 1 - exp ( - ( \frac{2 {γ}_{LG}}{{r}_{e}^{12}} + \frac{ρ g}{9 {r}_{e}^{10}} ) \frac{24 λ {V}^{4} ( t + {t}_{0} )}{{π}^{2} η} ) ]}^{\frac{1}{6}} ;$$
expressing said droplet with said radius over time r(t), by assuming perfect spreading of said droplets and a delay time, as:
$$r ( t ) = {[ {( {γ}_{LG} \frac{96 λ {V}^{4}}{{π}^{2} η} ( t + {t}_{0} ) )}^{\frac{1}{2}} + {( \frac{λ ( t + {t}_{0} )}{η} )}^{\frac{2}{3}} \frac{24 ρ {gV}^{\frac{3}{8}}}{7 \cdot {96}^{\frac{1}{3}} {π}^{\frac{4}{3}} {γ}_{LG}^{\frac{1}{3}}} ]}^{\frac{1}{6}} ,$$
γLG is the surface tension of the liquid
V is the droplet volume
η is the viscosity of the liquid
ρ is the density of the liquid
g is the gravitational acceleration constant
λ is the shape factor, 37.1 m-1
t0 is the experimental delay time
re is the radius of the droplet at equilibrium
making distances between adjacent one or more said puncture channels of said flow control single sheets as a multiple of said radius over time r(t);
making radii of one or more said puncture channels of said flow control single sheets no bigger than said radius over time r(t);
adjusting said distances between adjacent said puncture channels of same said flow control single sheet and said radii of said puncture channels of same said flow control single sheet to be one or more values depending on locations of said puncture channels on same said flow control single sheet; and
adjusting said distances between adjacent one or more said puncture channels of said flow control single sheets and said radii of one or more said puncture channels of said flow control single sheets based on physical parameters, at any combination of one or more locations of said conversion cell, from any combination of one or more options, comprising: temperature, liquid pressure, gas pressure, and gas flow rate.

6) The method of claim 3 wherein said building nonconductive said flow control single sheets following design parameters, further comprises with actions selected from any combination of one or more options, comprising:
expressing height h of a liquid column as:
$$h = \frac{2 γcosθ}{ρ gr} ,$$
γ is liquid-air surface tension coefficient (force/unit length),
θ is contact angle,
ρ is density of liquid,
g is gravitational acceleration constant,
r is said radius over time r(t);
making thickness of one or more said puncture channels of said flow control single sheets no thicker than said height h;
making spacing between adjacent said flow control single sheets be a multiple of said height h; and
adjusting said thickness of said flow control single sheets and said spacing between adjacent said flow control single sheets based on physical parameters, at any combination of one or more locations of said conversion cell, from any combination of one or more options, comprising:
temperature, liquid pressure, gas pressure, and gas flow rate.

7) The method of claim 3 wherein said building nonconductive said flow control single sheets with one or more said puncture channels following design parameters, further comprises:
making one or more said puncture channels of said flow control single sheets having design patterns from any combination of one or more options, comprising: Y-shaped, X-shaped, and star-shaped design pattern.

8) The method of claim 3 wherein said building nonconductive said flow control single sheets further comprises with actions selected from any combination of one or more options, comprising:
manufacturing said flow control single sheets in a similar way as manufacturing said electron exchangers with said puncture channels;
chemical etching by applying chemicals to etch away specific points of material to form one or more said puncture channels;
plasma etching by applying plasma to etch away specific points of material to form one or more said puncture channels;
laser drilling by repeatedly applying a pulsing focused laser to material to cut away specific spots to form one or more said puncture channels; and
electroforming by electro depositing of material onto a mandrel to form one or more said puncture channels.

9) The method of claim 1 wherein said converting said liquid conversion solution into said gases further comprises:
adjusting physical parameters, at any combination of one or more locations of said conversion cell, from any combination of one or more parameter options, comprising: temperature, liquid pressure, gas pressure, and gas flow rate.

10) The method of claim 10 wherein adjusting physical parameters at any combination of one or more locations of said conversion cell further comprises actions selected from any combination of one or more options, comprising:
placing valves, at any combination of one or more locations of said conversion cell, from any combination of one or more options, comprising: liquid flow valve, and gas flow valve;
placing sensors, at any combination of one or more locations of said conversion cell, from any combination of one or more options, comprising: liquid content sensors, temperature sensors, liquid pressure sensors, gas pressure sensors, and gas flow sensors;
placing a liquid flow valve at liquid inlet of said liquid conversion solution to said liquid flow controller and controlling amount and rate of said liquid conversion solution flowing to said liquid flow controller;
placing gas flow valves at gas chamber outlets of said gas chambers to control amount and rate of gas outflow from said gas chambers;
placing a liquid content sensor at liquid inlet side of said liquid flow controller;
placing a liquid content sensor at middle area of said liquid flow controller;
placing a liquid content sensor at bottom of said cathode gas chamber;
placing a liquid content sensor at bottom of said anode gas chamber;
placing temperature sensors at said gas chambers or liquid conversion solution chamber;
placing gas pressure sensors at said gas chambers;
placing said liquid pressure sensor in said liquid conversion solution chamber;
placing temperature sensors at any combination of one or more locations in said conversion cell;
placing liquid pressure sensors at any combination of one or more locations in said conversion cell;
placing gas pressure sensors at any combination of one or more locations in said conversion cell;
placing gas flow sensors at said gas chamber outlets of said gas chambers; and
placing said sensors at any combination of one or more locations of said conversion cell.

11) The method of claim 11 wherein said placing valves or sensors, further comprises:
using a computing engine by combining computing capabilities with computing devices selected from any combination of one or more options, comprising: a microprocessor, a local based computer connected by networks, and a cloud based computer connected by Internet; and
using said computing engine to exchange data with or to control devices selected from any combination of one or more options, comprising: said sensors, and said valves.

12) The method of claim 12 wherein said using said computing engine to carry out actions further comprises:
using said computing engine to carry out machine learning regression analysis by using analysis selected from any combination of one or more options, comprising: single variable regression, multi variable regression, linear regression, and nonlinear regression;
carrying said regression analysis with steps selected from any combination of one or more options, comprising:
expressing a multi variable linear regression function as an illustration as Y=C+M1×X1+M2×X2+M3×X3+ . . . +Mn×Xn;
expressing predictive function F(X) for said regression analysis as:
Y=F(X1, X2, . . . , Xn),
decision parameter as Y,
sensor 1 data as X1,
sensor 2 data as X2,
sensor N data or required gases output level as Xn;
expressing as X1, X2 to Xn for input data from said sensors or required gases output level;
setting Xn to 1 when said input data is within an acceptable range and setting Xn to 0 when said input data is out of said acceptable range;
evaluating value of said decision parameter Y to determine commands to send to control said sensors or said valves;
training said predictive function to become more accurate by collecting said input data and commonly accepted said decision parameters as training data and feeding into said predictive function; and
applying said predictive function in predicting future said decision parameters after said predictive function is fully trained to become an accurate model.

13) The method of claim 1 wherein said converting said liquid conversion solution into said gases in said conversion cell further comprises with actions selected from any combination of one or more options, comprising:
converting one or more kinds of said liquid conversion solution into one or more kinds of said gases;
converting liquid water into hydrogen gas and oxygen gas;
stacking two or more said conversion cells vertically and horizontally; and
sharing common components among said two or more said conversion cells.
